(19) United States
(12) Patent Application Publication
(10) Pub. No.: US 2009/0062968 A1
(43) Pub. Date: Mar. 5, 2009

(54) System and method for coordinating transfer of electricity

(75) Inventor: Scott Alan Leman, Eureka, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/896,390

(22) Filed: Aug. 31, 2007

(51) Int. Cl. B60K 6/22; G05D 7/00

(52) U.S. Cl. 700/286; 180/65.8; 903/902

(57) ABSTRACT

A system for coordinating transfer of electricity between parked mobile machines is disclosed. Each parked mobile machine may include a propulsion system operable to propel the mobile machine, and one or more of the mobile machines may have an electricity-generation system. The system may include one or more information-processing devices that automatically coordinate one or more aspects of the transfer of electricity between a plurality of the parked mobile machines. The one or more information-processing devices may coordinate one or more aspects of the transfer of electricity between the plurality of parked mobile machines by receiving information relating to one or more of the parked mobile machines and automatically determining which of the parked mobile machines will supply electricity to one or more of the other parked mobile machines based at least in part on the received information.

### TECHNICAL FIELD

The present disclosure relates to mobile machines that have electrical systems and, more particularly, to transfer of electricity between a parked mobile machine and one or more electrical systems or components external to the parked mobile machine.

### BACKGROUND

Many types of machines are mobile machines constructed at least partially for the purpose of providing transportation. Such mobile machines include, but are not limited to, trucks, tractor trailers, cars, tractors, wheel loaders, watercraft, and aircraft. Many mobile machines have an electrical system that includes one or more electrical power loads and an electricity-generation system for supplying electricity to those electrical power loads. Typically, the electricity-generation system of a mobile machine is used only to supply electricity to the electrical power loads of the mobile machine's electrical system. Using the electricity-generation system of a mobile machine only to supply electricity to its electrical power loads fails to capitalize on the potential to support the electricity needs of other electrical power loads with the mobile machine's electricity-generation system when the mobile machine is parked.

U.S. Pat. No. 6,649,289 to Hsu et al. (“the '289 patent”) discloses supplying electricity from the electricity-generation system of a parked mobile machine to various external electrical loads, such as a residence, a local utility power grid, or another parked vehicle. The system disclosed by the '289 patent includes a fuel line for supplying fuel to the electricity-generation system of a parked mobile machine and a power line for supplying electricity from the parked mobile machine's electricity-generation system to external electrical loads. The '289 patent discloses that the system may also include an inverter for converting DC current generated by the mobile machine's electricity-generation system into AC current for use in the electric utility grid.

Although the '289 patent discloses supplying electricity from the electricity-generation system of a parked mobile machine to various external electrical loads, such as a residence, a local utility power grid, or another parked vehicle, certain disadvantages persist. For example, the '289 patent does not disclose any practical method for coordinating the details of transferring electricity between a plurality of parked mobile machines, such as which of the electrically connected parked mobile machines will supply electricity and which will receive electricity.

The power system of the present disclosure solves one or more of the problems set forth above.

### SUMMARY OF THE INVENTION

One disclosed embodiment relates to a system for coordinating transfer of electricity between parked mobile machines. Each parked mobile machine may include a propulsion system operable to propel the mobile machine, and one or more of the mobile machines may have an electricity-generation system. The system may include one or more information-processing devices that automatically coordinate one or more aspects of the transfer of electricity between a plurality of the parked mobile machines. The one or more information-processing devices may coordinate one or more aspects of the transfer of electricity between the plurality of parked mobile machines by receiving information relating to one or more of the parked mobile machines and automatically determining which of the parked mobile machines will supply electricity to one or more of the other parked mobile machines based at least in part on the received information.

Another embodiment relates to a method for coordinating transfer of electricity between parked mobile machines. Each of the parked mobile machines may have a propulsion system operable to propel the mobile machine, and one or more of the parked mobile machines may have an electricity-generation system. The method may include automatically selecting with one or more information-processing devices one or more of a plurality of the parked mobile machines to supply electricity. The method may also include automatically determining with the one or more information-processing devices which of the plurality of parked mobile machines will receive electricity from the one or more mobile machines selected to supply electricity.

A further embodiment relates to a method for coordinating supply of electricity from one or more of a plurality of parked mobile machines to one or more external power loads. Each of the parked mobile machines may have a propulsion system operable to propel the mobile machine, and one or more of the mobile machines may have an electricity-generation system. The method may include automatically selecting with one or more information-processing devices one or more of the plurality of parked mobile machines that will supply electricity to one or more external power loads based at least in part on one or more laws or regulations relating to operation of parked mobile machines.

### BRIEF DESCRIPTION OF THE DRAWINGS

FIG. 1A shows an arrangement according to the present disclosure for coordinating transfer of electricity to and from parked mobile machines;

FIG. 1B shows one of the parked mobile machines of FIG. 1A in greater detail;

FIG. 1C shows another of the parked mobile machines of FIG. 1A in greater detail;

FIG. 1D shows another of the parked mobile machines of FIG. 1A in greater detail;

FIG. 1E shows another of the parked mobile machines of FIG. 1A in greater detail;

FIG. 2A is a flow chart illustrating a method according to the present disclosure;

FIG. 2B is a flow chart showing in greater detail one embodiment of a portion of the method shown in FIG. 2A; and

FIG. 2C is a flow chart showing in greater detail another embodiment of a portion of the method shown in FIG. 2A.

### DETAILED DESCRIPTION

The present disclosure relates to transferring electricity between an electrical system of a parked mobile machine and one or more external electrical systems and/or components. For purposes of this disclosure, relative to any particular mobile machine, an “external electrical system and/or component” means any electrical system or component not forming part of that mobile machine. For example, relative to any particular mobile machine, electrical systems and components of other mobile machines constitute external electrical systems and components. Additionally, various other types of electrical systems and components not forming part of a mobile machine may constitute external electrical systems and components with respect to that mobile machine.

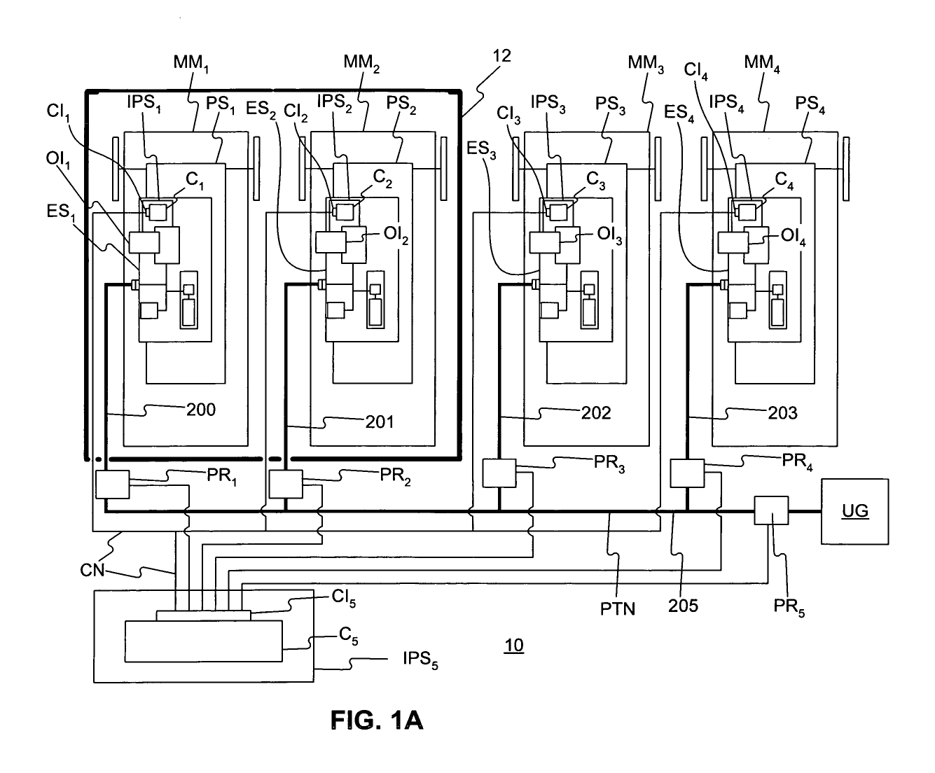

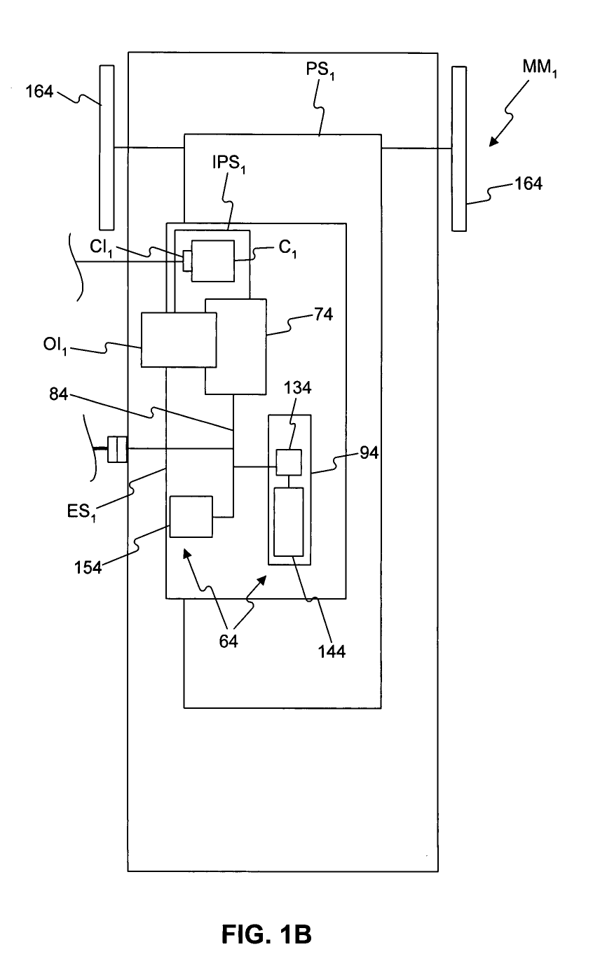

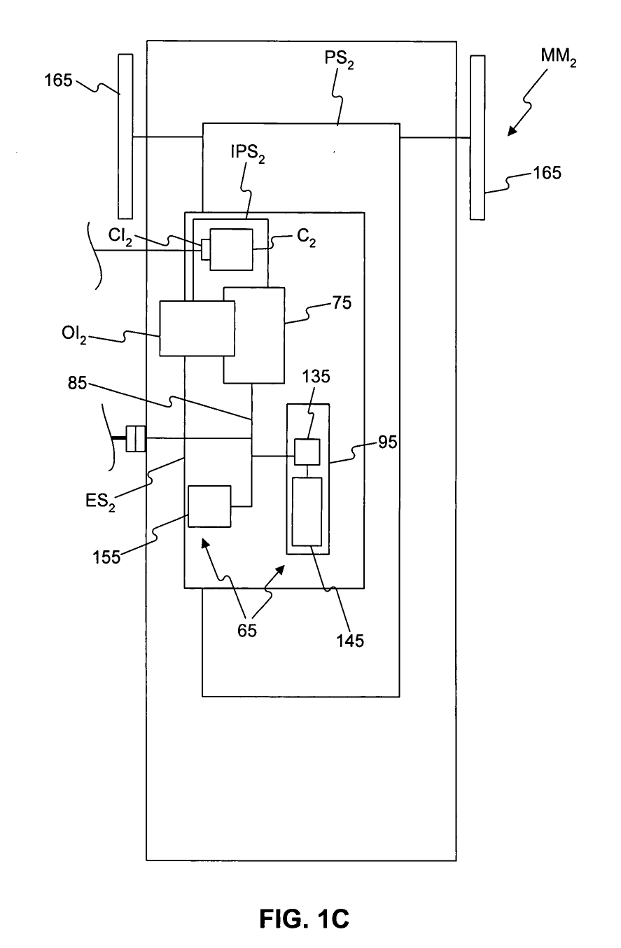

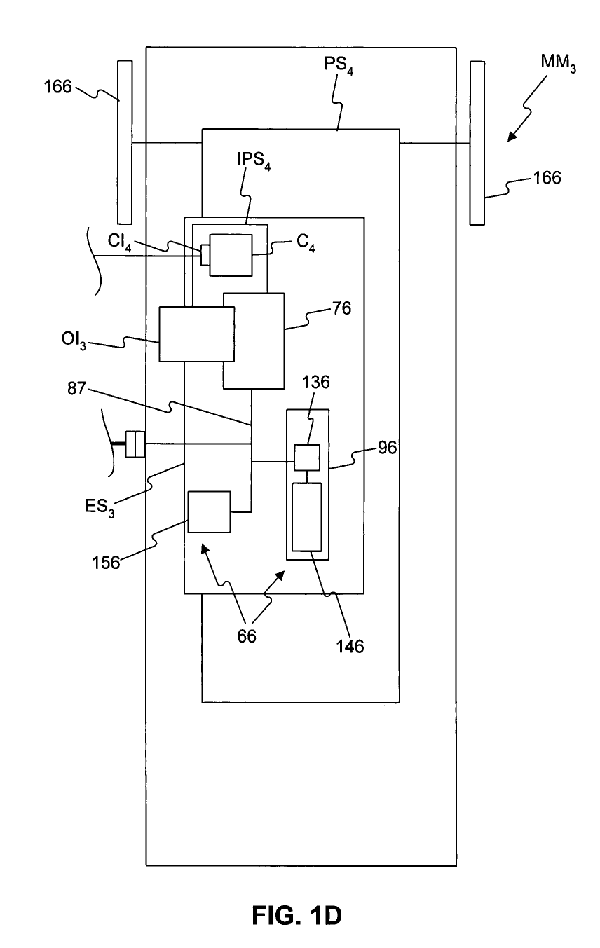

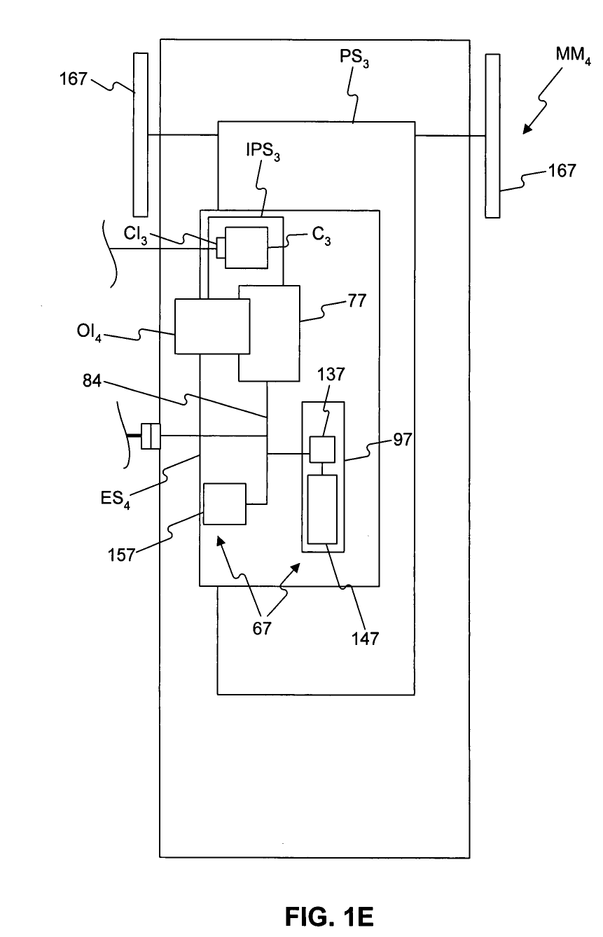

FIG. 1A illustrates a plurality of mobile machines MM₁, MM₂, MM₃, MM₄, each having an electrical system ES₁, ES₂, ES₃, ES₄, parked in a parking lot 10. Each of mobile machines MM₁, MM₂, MM₃, MM₄ may be any type of machine configured to provide transportation, including, but not limited to, a truck, a tractor trailer, a car, a tractor, a wheel loader, a watercraft, or an aircraft. In addition to its electrical system ES₁, ES₂, ES₃, ES₄, each of mobile machines MM₁, MM₂, MM₃, MM₄ may include a propulsion system PS₁, PS₂, PS₃, PS₄ operable to propel the mobile machine MM₁, MM₂, MM₃, MM₄; an operator interface OI₁, OI₂, OI₃, OI₄; and an information-processing system IPS₁, IPS₂, IPS₃, IPS₄.

One or more of mobile machines MM₁, MM₂, MM₃, MM₄ may be parked in a structure that helps insulate other portions of parking lot 10 and surrounding areas from sound generated by the mobile machine MM₁, MM₂, MM₃, MM₄. For example, mobile machines MM₁, MM₂ may be parked in a structure 12, which may help insulate areas outside of structure 12 from sound generated by mobile machines MM₁, MM₂.

In any one of mobile machines MM₁, MM₂, MM₃, MM₄, the electrical system ES₁, ES₂, ES₃, ES₄, the propulsion system PS₁, PS₂, PS₃, PS₄, and/or the information-processing system IPS₁, IPS₂, IPS₃, IPS₄ may overlap with one another. In other words, certain components of the mobile machine MM₁, MM₂, MM₃, MM₄ may form part of two or more of the above-listed systems of the mobile machine MM₁, MM₂, MM₃, MM₄. For example, as shown in FIG. 1A, the electrical system ES₁, ES₂, ES₃, ES₄ of each mobile machine MM₁, MM₂, MM₃, MM₄ may include parts of the propulsion system PS₁, PS₂, PS₃, PS₄ and the information-processing system IPS₁, IPS₂, IPS₃, IPS₄.

FIGS. 1B-1E each show one of mobile machines MM₁, MM₂, MM₃, MM₄ in greater detail. As shown in FIG. 1B, the electrical system ES₁, ES₂, ES₃, ES₄ of each mobile machine MM₁, MM₂, MM₃, MM₄ may include electricity sources 64, 65, 66, 67, electrical power loads 74, 75, 76, 77, and a circuitry 84, 85, 86, 87 for carrying electricity between components of the electrical system ES₁, ES₂, ES₃, ES₄.

The electricity sources 64, 65, 66, 67 of one or more of mobile machines MM₁, MM₂, MM₃, MM₄ may include an electricity-generation system 94, 95, 96, 97. The electricity-generation system 94, 95, 96, 97 of a mobile machine MM₁, MM₂, MM₃, MM₄ may include any component or components operable to generate electricity. For example, an electricity-generation system 94, 95, 96, 97 may include an electric generator 134, 135, 136, 137 drivingly connected to a power source 144, 145, 146, 147. Each power source 144, 145, 146, 147 may be any type of device operable to produce mechanical power, including, but not limited to, a diesel engine, a gasoline engine, a gaseous-fuel-driven engine, and a turbine engine. Each electric generator 134, 135, 136, 137 may be any type of device operable to convert mechanical power received from the associated power source 144, 145, 146, 147 into electricity, including, but not limited to, an AC induction generator, a permanent-magnet generator, an AC synchronous generator, or a switched-reluctance generator.

The electricity-generation capacity of each electricity-generation system 94, 95, 96, 97 may depend on what needs the electricity-generation system 94, 95, 96, 97 is intended to serve. For example, where the propulsion system PS₁, PS₂, PS₃, PS₄ has a so-called hybrid electric configuration, the corresponding electricity-generation system 94, 95, 96, 97 may have a relatively high generating capacity so that it can supply sufficient electricity for propulsion purposes. On the other hand, where the propulsion system PS₁, PS₂, PS₃, PS₄ of a mobile machine MM₁, MM₂, MM₃, MM₄ has a so-called conventional configuration, the corresponding electricity-generation system 94, 95, 96, 97 may have a lower generation capacity suitable for meeting power needs other than propulsion. Accordingly, different ones of electricity-generation systems 94, 95, 96, 97 may have significantly different electricity-generation capacities.

The electricity sources 64, 65, 66, 67 of one or more of mobile machines MM₁, MM₂, MM₃, MM₄ may also include one or more electricity storage devices 154, 155, 156, 157. Electricity storage devices 154, 155, 156, 157 may be various types of components configured to store electricity for use by other components of the electrical system ES₁, ES₂, ES₃, ES₄, including, but not limited to, batteries and capacitors.

The electricity sources 64, 65, 66, 67 of mobile machines MM₁, MM₂, MM₃, MM₄ are not limited to the examples shown in FIGS. 1B-1E. Electricity-generation systems 94, 95, 96, 97 may include other electric generators, in addition to the electric generator 134, 135, 136, 137 shown in FIGS. 1B-1E. Such other electric generators may be driven by one of power sources 144, 145, 146, 147 or by another power source of the associated mobile machine MM₁, MM₂, MM₃, MM₄. Additionally, in some embodiments, one or more of electricity-generation systems 94, 95, 96, 97 may include one or more types of devices other than a mechanically driven electric generator for generating electricity, such as, for example, a fuel cell.

The electrical power loads 74, 75, 76, 77 of each mobile machine MM₁, MM₂, MM₃, MM₄ may include any devices or systems that consume electricity. For example, the electrical power loads 74, 75, 76, 77 of a mobile machine MM₁, MM₂, MM₃, MM₄ may include, but are not limited to, electric motors, lights, sound systems, heating systems, and/or cooling systems.

One or more components of an electrical system ES₁, ES₂, ES₃, ES₄ may serve as an electricity source 64, 65, 66, 67 in some circumstances while acting as a power load in other circumstances. For example, in some circumstances, rather than generating electricity, one or more of electric generators 134, 135, 136, 137 may operate as an electric motor for one or more purposes. Additionally, electricity storage devices 154, 155, 156, 157 may constitute electrical power loads when they receive electricity.

The propulsion system PS₁, PS₂, PS₃, PS₄ of each mobile machine MM₁, MM₂, MM₃, MM₄ may include any components operable to propel the mobile machine MM₁, MM₂, MM₃, MM₄. For example, each propulsion system PS₁, PS₂, PS₃, PS₄ may include one or more components for supplying power to propulsion devices 164, 165, 166, 167 that apply the power to the environment surrounding the mobile machine MM₁, MM₂, MM₃, MM₄ in a manner to propel the mobile machine MM₁, MM₂, MM₃, MM₄. Propulsion devices 164, 165, 166, 167 may include, but are not limited to, wheels, track units, and propellers.

In some embodiments, one or more of the propulsion systems PS₁, PS₂, PS₃, PS₄ of mobile machines MM₁, MM₂, MM₃, MM₄ may have a so-called “hybrid electric” configuration. A hybrid electric style propulsion system PS₁, PS₂, PS₃, PS₄ may be configured to drive its propulsion devices 164, 165, 166, 167 at least in part with electricity generated by the electricity-generation system 94, 95, 96, 97 of the mobile machine MM₁, MM₂, MM₃, MM₄. For example, a hybrid electric style propulsion system PS₁, PS₂, PS₃, PS₄ may include one or more electric propulsion motors (not shown) for driving propulsion devices 164, 165, 166, 167 using electricity from the associated electricity-generation system 94, 95, 96, 97. Additionally, or alternatively, a hybrid electric style propulsion system PS₁, PS₂, PS₃, PS₄ may sometimes use previously generated electricity to operate the associated electric generator 134, 135, 136, 137 as an electric motor to drive the associated propulsion devices 164, 165, 166, 167.

Of course, one or more of propulsion systems PS₁, PS₂, PS₃, PS₄ of mobile machines MM₁, MM₂, MM₃, MM₄ may be a type of propulsion system other than hybrid electric. For example, one or more of propulsion systems PS₁, PS₂, PS₃, PS₄ may be a fully electric propulsion system. Additionally, one or more of propulsion systems PS₁, PS₂, PS₃, PS₄ may include a conventional mechanical system for driving propulsion devices with power from the associated power source 144, 145, 146, 147.

The operator interface OI₁, OI₂, OI₃, OI₄ of each mobile machine MM₁, MM₂, MM₃, MM₄ may include any component or components configured to transmit operator inputs to one or more other components of the mobile machine MM₁, MM₂, MM₃, MM₄. For example, each operator interface OI₁, OI₂, OI₃, OI₄ may include one or more handles, pedals, buttons, switches, touch pads, keypads, and/or keyboards operatively connected to one or more other components of the mobile machine MM₁, MM₂, MM₃, MM₄. Such components are not illustrated in FIGS. 1A-1E.

The information-processing system IPS₁, IPS₂, IPS₃, IPS₄ of each mobile machine MM₁, MM₂, MM₃, MM₄ may include one or more information-processing devices of various types. As shown in FIGS. 1B-1E, in some embodiments, each information-processing system IPS₁, IPS₂, IPS₃, IPS₄ may include a computer C₁, C₂, C₃, C₄ and a communication interface CI₁, CI₂, CI₃, CI₄. Each computer C₁, C₂, C₃, C₄ may include, for example, one or more microprocessors (not shown) and one or more memory devices (not shown). Each communication interface CI₁, CI₂, CI₃, CI₄ may be configured to transmit information between the associated computer C₁, C₂, C₃, C₄ and one or more other devices via wires, fiber optic channels, other physical lines, and/or wirelessly. As shown in FIG. 1A, information-processing systems IPS₁, IPS₂, IPS₃, IPS₄ may be communicatively linked to one another by a communication network CN that transmits information between communication interfaces CI₁, CI₂, CI₃, CI₄.

In addition to receiving information from other information-processing systems IPS₁, IPS₂, IPS₃, IPS₄ over communication network CN, each information-processing system IPS₁, IPS₂, IPS₃, IPS₄ may receive information from other sources through various other channels. For example, each information-processing system IPS₁, IPS₂, IPS₃, IPS₄ may receive information from various components and systems of the mobile machine MM₁, MM₂, MM₃, MM₄ to which it belongs, including, but not limited to, the associated operator interface OI₁, OI₂, OI₃, OI₄ and various sensors. One or more of information-processing systems IPS₁, IPS₂, IPS₃, IPS₄ may also communicate with other information systems that are not part of the mobile machine MM₁, MM₂, MM₃, MM₄, including, but not limited to, cell phones and remote computers.

Additionally, one or more of information-processing systems IPS₁, IPS₂, IPS₃, IPS₄ may form part of and/or communicate with one or more of the control systems of the mobile machine MM₁, MM₂, MM₃, MM₄. For example, each information-processing system IPS₁, IPS₂, IPS₃, IPS₄ may form part of and/or communicate with the control system of the electrical system ES₁, ES₂, ES₃, ES₄ of the mobile machine MM₁, MM₂, MM₃, MM₄. Similarly, the information-processing system IPS₁, IPS₂, IPS₃, IPS₄ may form part of and/or communicate with the control system of the propulsion system PS₁, PS₂, PS₃, PS₄ of the mobile machine MM₁, MM₂, MM₃, MM₄. Accordingly, the information-processing system IPS₁, IPS₂, IPS₃, IPS₄ of a mobile machine MM₁, MM₂, MM₃, MM₄ may directly or indirectly control one or more aspects of the operation of its electrical system ES₁, ES₂, ES₃, ES₄ and/or its propulsion system PS₁, PS₂, PS₃, PS₄.

When a mobile machine MM₁, MM₂, MM₃, MM₄ is parked, its electrical system ES₁, ES₂, ES₃, ES₄ may be electrically connected to one or more external electrical systems or components. For example, as shown in FIG. 1A, electrical systems ES₁, ES₂, ES₃, ES₄ may all be connected to one another and also to an electric utility grid UG by a power-transfer network PTN. Power-transfer network PTN may include power lines 200, 201, 202, 203, 205 connecting electrical systems ES₁, ES₂, ES₃, ES₄ to one another and to electric utility grid UG.

Power-transfer network PTN may also include provisions for controlling the flow of electricity in power lines 200, 201, 202, 203, 205. For example, power-transfer network PTN may include power regulators PR₁, PR₂, PR₃, PR₄, PR₅ in power lines 200, 201, 202, 203, 205, respectively. Each power regulator PR₁, PR₂, PR₃, PR₄, PR₅ may be any type of component configured to control one or more aspects of electrical activity in the associated power line 200, 201, 202, 203, 205. For example, each power regulator PR₁, PR₂, PR₃, PR₄, PR₅ may control whether and in what direction electricity flows in the associated power line 200, 201, 202, 203, 205. Additionally, one or more of power regulators PR₁, PR₂, PR₃, PR₄, PR₅ may control the magnitude of electric current and/or voltage in the associated power line 200, 201, 202, 203, 205. One or more of power regulators PR₁, PR₂, PR₃, PR₄, PR₅ may also alter one or more characteristics of the electricity flowing through the associated power line 200, 201, 202, 203, 205. For example, power regulator PR₅ may convert between AC current on the side of power line 205 connected to electric utility grid UG and DC current on the side of power line 205 connected to electrical systems ES₁, ES₂, ES₃, ES₄.

External to mobile machines MM₁, MM₂, MM₃, MM₄, there may be an information-processing system IPS₅. Information-processing system IPS₅ may include one or more of various types of information-processing devices. As shown in FIG. 1A, in some embodiments, information-processing system IPS₅ may include a computer C₅ and a communication interface CI₅. Computer C₅ may include one or more microprocessors (not shown) and/or one or more memory devices (not shown). Communication interface CI₅ may be configured to transmit information between computer C₅ and one or more other devices wirelessly and/or via physical communication lines, such as wires or fiber optic channels. In some embodiments, communication interface CI₅ may be connected to communication network CN, thereby allowing information-processing system IPS₅ to communicate with information-processing systems IPS₁, IPS₂, IPS₃, IPS₄.

Additionally, computer C₅ may be communicatively linked through communication interface CI₅ to each of power regulators PR₁, PR₂, PR₃, PR₄, PR₅. This may enable information-processing system IPS₅ to control the flow of electricity within power-transfer network PTN by controlling power regulators PR₁, PR₂, PR₃, PR₄, PR₅.

Connecting mobile machines MM₁, MM₂, MM₃, MM₄ to one another with power-transfer network PTN may enable transfer of electricity from the electrical system ES₁, ES₂, ES₃, ES₄ of one or more of mobile machines MM₁, MM₂, MM₃, MM₄ to the electrical system ES₁, ES₂, ES₃, ES₄ of one or more other mobile machines MM₁, MM₂, MM₃, MM₄. Additionally, connecting mobile machines MM₁, MM₂, MM₃, MM₄ to electric utility grid UG with power-transfer network PTN may allow transfer of electricity between the electrical system ES₁, ES₂, ES₃, ES₄ of one or more of mobile machines MM₁, MM₂, MM₃, MM₄ and electric utility grid UG.

Power-transfer network PTN may transfer electricity to and/or from the electrical system ES₁, ES₂, ES₃, ES₄ of a mobile machine MM₁, MM₂, MM₃, MM₄ in the form of DC current or AC current. Where an electrical system ES₁, ES₂, ES₃, ES₄ operates in whole or in part with a different type of electricity than it receives from and/or supplies to power-transfer network PTN, that electrical system ES₁, ES₂, ES₃, ES₄ may have internal provisions for converting between AC current and DC current. The inclusion of power regulators PR₁, PR₂, PR₃, PR₄, PR₅ in power-transfer network PTN may allow transfer of AC current to and/or from one or more of electrical systems ES₁, ES₂, ES₃, ES₄ simultaneous with transfer of DC current to and/or from one or more others of electrical systems ES₁, ES₂, ES₃, ES₄. Additionally, in some embodiments, power-transfer network PTN may include one or more circuits for transferring DC current to and/or from one or more of electrical systems ES₁, ES₂, ES₃, ES₄ in combination with one or more separate circuits for transferring AC current to and/or from one or more of electrical systems ES₁, ES₂, ES₃, ES₄.

One or more of information-processing systems IPS₁, IPS₂, IPS₃, IPS₄, IPS₅ may serve to coordinate transfer of electricity among mobile machines MM₁, MM₂, MM₃, MM₄ and electric utility grid UG. This may involve determining which of mobile machines MM₁, MM₂, MM₃, MM₄ will supply electricity to one or more of the other mobile machines MM₁, MM₂, MM₃, MM₄ and/or to electric utility grid UG. It may also involve determining which of mobile machines MM₁, MM₂, MM₃, MM₄ will receive electricity from one or more of the other mobile machines MM₁, MM₂, MM₃, MM₄ and/or electric utility grid UG. Methods that one or more of information-processing systems IPS₁, IPS₂, IPS₃, IPS₄ may use to coordinate transfer of electricity among mobile machines MM₁, MM₂, MM₃, MM₄ and electric utility grid UG are discussed in greater detail below.

An arrangement according to the present disclosure for transferring electricity between the electrical systems ES₁, ES₂, ES₃, ES₄ of one or more parked mobile machines MM₁, MM₂, MM₃, MM₄ is not limited to the examples discussed above and illustrated in FIGS. 1A-1E. For example, one or more of information-processing systems IPS₁, IPS₂, IPS₃, IPS₄, IPS₅ may have a different configuration. In addition to, or in place of, computers C₁, C₂, C₃, C₄, C₅, information-processing systems IPS₁, IPS₂, IPS₃, IPS₄, IPS₅ may include other types of information-processing components, including, but not limited to, hard-wired control circuits. Additionally, there may be other information-processing systems that interact with one or more of the information-processing systems IPS₁, IPS₂, IPS₃, IPS₄, IPS₅ shown in FIGS. 1A-1E.

Power-transfer network PTN may also have a different configuration than that shown in FIG. 1A. For example, power-transfer network PTN may have a different number and/or arrangement of power lines than shown in FIG. 1A. In addition to mobile machines MM₁, MM₂, MM₃, MM₄ and electric utility grid UG, various other electrical systems and/or components, including electrical systems of one or more other mobile machines, may be connected to power-transfer network PTN. Similarly, one or more of electrical systems ES₁, ES₂, ES₃, ES₄ of mobile machines MM₁, MM₂, MM₃, MM₄ and/or electric utility grid UG may not be connected to power-transfer network PTN. In some embodiments, a mobile machine MM₁, MM₂, MM₃, MM₄ may have its electrical system ES₁, ES₂, ES₃, ES₄ connected to the electrical system ES₁, ES₂, ES₃, ES₄ of only one other mobile machine MM₁, MM₂, MM₃, MM₄. Additionally, power-transfer network PTN may omit one or more of power regulators PR₁, PR₂, PR₃, PR₄, PR₅ and/or include one or more power regulators not shown in FIG. 1A. Similarly, power-transfer network PTN may include various other electrical components not shown in FIG. 1A.

Additionally, structure 12 may have more, fewer, and/or different ones of mobile machines MM₁, MM₂, MM₃, MM₄ parked therein. Parking lot 10 may also have additional sound-insulating structures within which one or more of mobile machines MM₁, MM₂, MM₃, MM₄ may park. Alternatively, parking lot 10 may omit structure 12, leaving all of mobile machines MM₁, MM₂, MM₃, MM₄ parked in the open.

### INDUSTRIAL APPLICABILITY

One or more of information-processing systems IPS₁, IPS₂, IPS₃, IPS₄, IPS₅ may have application for coordinating transfer of electricity between the electrical systems ES₁, ES₂, ES₃, ES₄ of one or more parked mobile machines MM₁, MM₂, MM₃, MM₄ and one or more external power loads in any circumstances where such a transfer of electricity may prove beneficial. Various combinations of one or more of information-processing systems IPS₁, IPS₂, IPS₃, IPS₄, IPS₅ may execute various algorithms for coordinating transfer of electricity among mobile machines MM₁, MM₂, MM₃, MM₄ and electric utility grid UG.

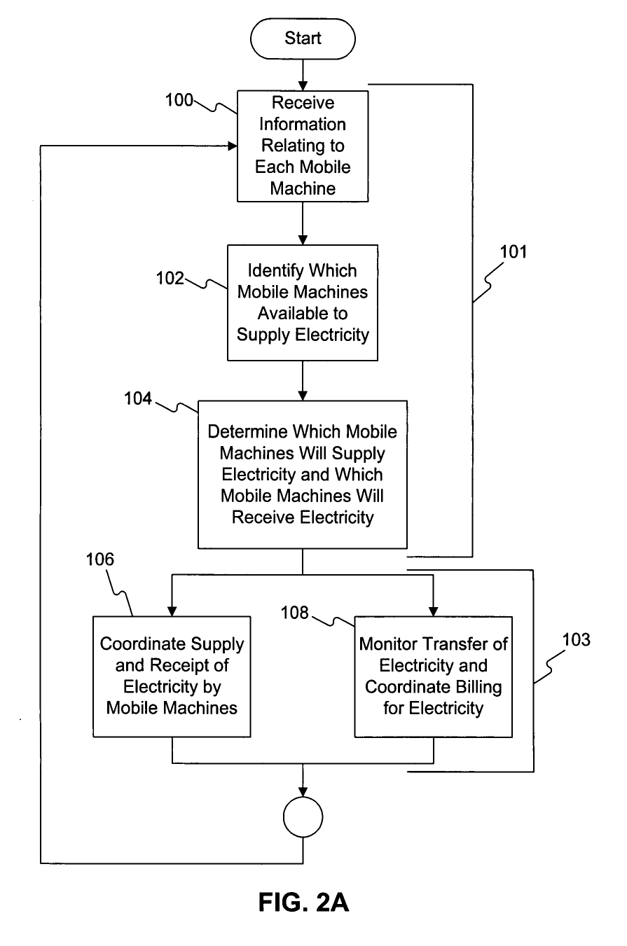

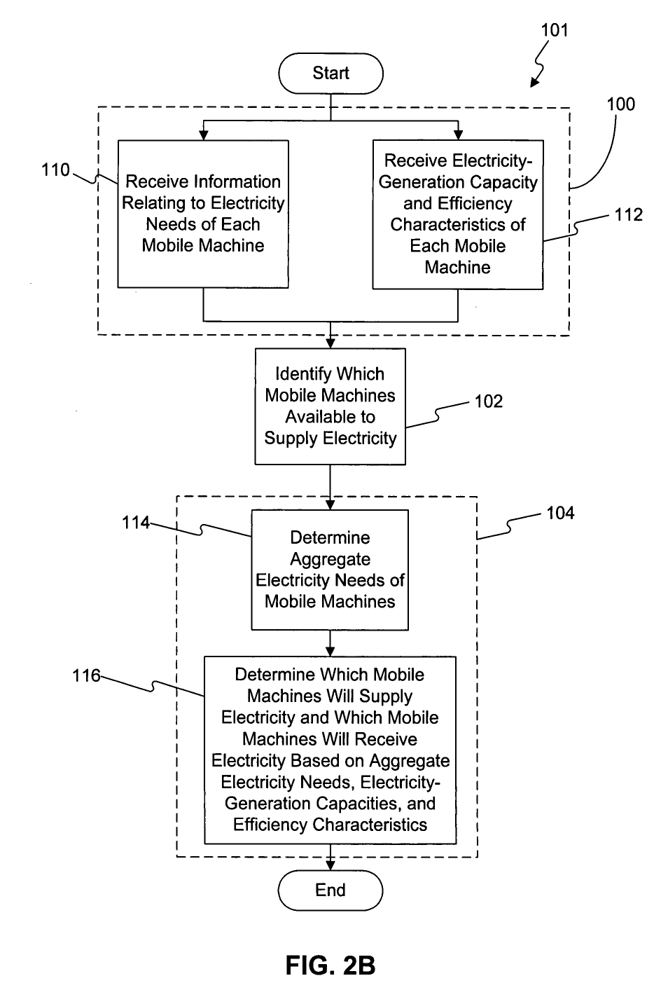

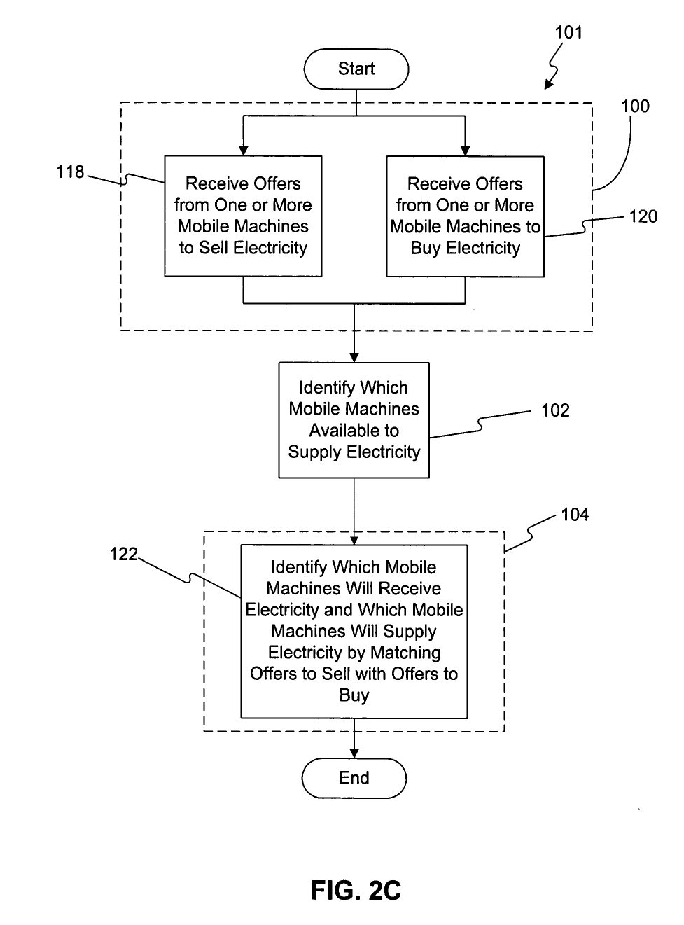

In some embodiments, information-processing system IPS₅ may execute the algorithm shown in FIG. 2A to coordinate transfer of electricity among mobile machines MM₁, MM₂, MM₃, MM₄ and electric utility grid UG. Information-processing system IPS₅ may execute the actions shown in FIG. 2A repeatedly. The method shown in FIG. 2A may include a planning phase 101 and an execution phase 103. In planning phase 101, information-processing system IPS₅ may initially receive information relating to each of mobile machines MM₁, MM₂, MM₃, MM₄ via communication network CN (step 100). This information may include, but is not limited to, identifying information for one or more of mobile machines MM₁, MM₂, MM₃, MM₄; information about the configuration and/or condition of one or more of mobile machines MM₁, MM₂, MM₃, MM₄; information about the electricity needs of one or more of mobile machines MM₁, MM₂, MM₃, MM₄; and/or information about the terms under which owners of mobile machines MM₁, MM₂, MM₃, MM₄ are willing to receive and supply electricity. Information-processing system IPS₅ may receive such information, for example, over communication network CN from information-processing systems IPS₁, IPS₂, IPS₃, IPS₄ of mobile machines MM₁, MM₂, MM₃, MM₄.

After receiving information relating to each of mobile machines MM₁, MM₂, MM₃, MM₄, information-processing system IPS₅ may identify which of mobile machines MM₁, MM₂, MM₃, MM₄ are available to supply electricity (step 102). Information-processing system IPS₅ may do so based on the received information related to each of the mobile machines MM₁, MM₂, MM₃, MM₄ and/or various other information. In some embodiments, information-processing system IPS₅ may determine which of mobile machines MM₁, MM₂, MM₃, MM₄ are available to supply electricity based in part on information related to the condition of each mobile machine MM₁, MM₂, MM₃, MM₄, such as whether its state of repair allows it to supply electricity. Additionally, information-processing system IPS₅ may determine the availability of each mobile machine MM₁, MM₂, MM₃, MM₄ to supply electricity based at least in part on whether the owner of the mobile machine MM₁, MM₂, MM₃, MM₄ has expressed willingness to supply electricity.

Information-processing system IPS₅ may also determine the availability of each mobile machine MM₁, MM₂, MM₃, MM₄ to supply electricity based in part on one or more laws or regulations relating to operation of parked mobile machines. Such laws or regulations may specify, for example, when and for how long an engine of a parked mobile machine can run. Thus, where the electricity-generation system 94, 95, 96, 97 of a mobile machine MM₁, MM₂, MM₃, MM₄ has an engine as its power source 144, 145, 146, 147, such laws may limit when and for how long that mobile machine MM₁, MM₂, MM₃, MM₄ can supply electricity. Accordingly, when determining which of parked mobile machines MM₁, MM₂, MM₃, MM₄ are available to supply electricity, information-processing system IPS₅ may use information about the recent operation of one or more of mobile machines MM₁, MM₂, MM₃, MM₄ to determine if they can lawfully operate to supply electricity.

After determining which of mobile machines MM₁, MM₂, MM₃, MM₄ are available to supply electricity, information-processing system IPS₅ may determine which of mobile machines MM₁, MM₂, MM₃, MM₄ will supply electricity and which will receive electricity (step 104). Information-processing system IPS₅ may do so based on various factors, including, but not limited to, the electricity needs of each mobile machine MM₁, MM₂, MM₃, MM₄; the electricity-generation capacity and/or efficiency characteristics of one or more of the electricity-generation systems 94, 95, 96, 97 of mobile machines MM₁, MM₂, MM₃, MM₄; the terms under which the owners of mobile machines MM₁, MM₂, MM₃, MM₄ are willing to receive and/or supply electricity; and the price of electricity from electric utility grid UG. Details of two exemplary processes that information-processing system IPS₅ may use to determine which of mobile machines MM₁, MM₂, MM₃, MM₄ will supply electricity and which will receive electricity are discussed below in connection with FIGS. 2B and 2C.

In some embodiments, when selecting mobile machines MM₁, MM₂, MM₃, MM₄ to supply electricity, information-processing system IPS₅ may favor those parked in structure 12. This may involve using only those mobile machines MM₁, MM₂, MM₃, MM₄ parked in structure 12 to generate electricity. Alternatively, it may involve preferentially selecting those mobile machines MM₁, MM₂, MM₃, MM₄ parked in structure 12 to generate electricity while still electing to supply electricity with one or more of mobile machines MM₁, MM₂, MM₃, MM₄ not parked in structure 12 in at least some circumstances. Preferentially selecting those mobile machines MM₁, MM₂, MM₃, MM₄ that are parked in structure 12 to supply electricity may help limit the amount of noise transmitted to areas surrounding parking lot 10.

When determining which of mobile machines MM₁, MM₂, MM₃, MM₄ will supply electricity and which will receive electricity, information-processing system IPS₅ may determine that electricity transfer will occur only amongst mobile machines MM₁, MM₂, MM₃, MM₄, not between electric utility grid UG and mobile machines MM₁, MM₂, MM₃, MM₄. Alternatively, information-processing system IPS₅ may determine that one or more of mobile machines MM₁, MM₂, MM₃, MM₄ will supply electricity to electric utility grid UG and/or that one or more of mobile machines MM₁, MM₂, MM₃, MM₄ will receive electricity from electric utility grid UG.

With the mobile machines MM₁, MM₂, MM₃, MM₄ that will supply and receive electricity identified, information-processing system IPS₅ may coordinate supply and receipt of electricity by mobile machines MM₁, MM₂, MM₃, MM₄ (step 106). This may involve communicating to the information-processing system IPS₁, IPS₂, IPS₃, IPS₄ of each mobile machine MM₁, MM₂, MM₃, MM₄ selected to supply electricity when to begin supplying electricity and how much electricity to supply. Similarly, it may involve communicating to the information-processing system IPS₁, IPS₂, IPS₃, IPS₄ of each mobile machine MM₁, MM₂, MM₃, MM₄ selected to receive electricity how much electricity the mobile machine MM₁, MM₂, MM₃, MM₄ is to receive and when it will begin receiving that electricity. To coordinate supply and receipt of electricity to mobile machines MM₁, MM₂, MM₃, MM₄, information-processing system IPS₅ may also control power regulators PR₁, PR₂, PR₃, PR₄, PR₅ to control the flow of electricity amongst mobile machines MM₁, MM₂, MM₃, MM₄ and electric utility grid UG.

While coordinating the supply and receipt of electricity by mobile machines MM₁, MM₂, MM₃, MM₄, information-processing system IPS₅ may monitor the transfer of electricity and coordinate billing for the transferred electricity (step 108). For example, information-processing system IPS₅ may monitor the amount of electricity received by each mobile machine MM₁, MM₂, MM₃, MM₄, calculate a charge associated with that quantity of electricity, and take steps to initiate transmission of a bill for that electricity to the owners of those mobile machines MM₁, MM₂, MM₃, MM₄. Similarly, information-processing system IPS₅ may monitor the quantity of electricity supplied by each mobile machine MM₁, MM₂, MM₃, MM₄ supplying electricity and initiate a process by which the owners of those mobile machines may receive payment for the supplied electricity.

In some cases, information-processing system IPS₅ may automatically facilitate billing directly between the owners of those mobile machines MM₁, MM₂, MM₃, MM₄ supplying electricity and the owners of those mobile machines MM₁, MM₂, MM₃, MM₄ receiving electricity. Alternatively, the owner of information-processing system IPS₅ may purchase electricity from the owners of the mobile machines MM₁, MM₂, MM₃, MM₄ supplying electricity and sell that electricity to the owners of those mobile machines MM₁, MM₂, MM₃, MM₄ receiving electricity. Of course, information-processing system IPS₅ may also facilitate billing for electricity transferred between electric utility grid UG and one or more of mobile machines MM₁, MM₂, MM₃, MM₄.

FIG. 2B provides a more detailed example of how information-processing system IPS₅ may execute the planning phase 101 of the method shown in FIG. 2A. In this variation, the step of receiving information related to each mobile machine MM₁, MM₂, MM₃, MM₄ (step 100) may include receiving information relating to electricity needs of each mobile machine MM₁, MM₂, MM₃, MM₄ (step 110). For example, information-processing system IPS₅ may receive from the information-processing system IPS₁, IPS₂, IPS₃, IPS₄ of each mobile machine MM₁, MM₂, MM₃, MM₄ an indication of the quantity of electric current the electrical power loads 74, 75, 76, 77 the operator wants and/or needs to operate will require. The information-processing system IPS₁, IPS₂, IPS₃, IPS₄ of each mobile machine MM₁, MM₂, MM₃, MM₄ may, for example, determine this information based on inputs received from the associated operator interface OI₁, OI₂, OI₃, OI₄.

In step 100, information-processing system IPS₅ may also receive information about the electricity-generation capacity and efficiency characteristics of the electricity-generation system 94, 95, 96, 97 of each mobile machine MM₁, MM₂, MM₃, MM₄ (step 112). For example, the information-processing system IPS₁, IPS₂, IPS₃, IPS₄ of each mobile machine MM₁, MM₂, MM₃, MM₄ may transmit to information-processing system IPS₅ an indication of how much electricity the associated electricity-generation system 94, 95, 96, 97 can generate. Additionally, the information-processing system IPS₁, IPS₂, IPS₃, IPS₄ of each mobile machine MM₄, MM₂, MM₃, MM₄ may transmit to information-processing system IPS₅ information about how efficiently the associated electricity-generation system 94, 95, 96, 97 can generate various quantities of electricity.

As noted above, information-processing system IPS₅ may then identify which of mobile machines MM₁, MM₂, MM₃, MM₄ are available to supply electricity (step 102), followed by determining which of mobile machines MM₁, MM₂, MM₃, MM₄ will receive electricity and which will supply electricity (step 104). In the embodiment shown in FIG. 2B, step 104 includes determining the aggregate electricity needs of mobile machines MM₁, MM₂, MM₃, MM₄ (step 114), such as by summing the quantities received in step 110.

Subsequently, information-processing system IPS₅ may determine which of mobile machines MM₁, MM₂, MM₃, MM₄ will receive electricity and which will supply electricity based on the aggregate electricity needs of mobile machines MM₁, MM₂, MM₃, MM₄ in combination with the electricity-generation capacities and efficiency characteristics of the electricity-generation systems 94, 95, 96, 97 of mobile machines MM₁, MM₂, MM₃, MM₄ (step 116). For example, information-processing system IPS₅ may identify one or more combinations of mobile machines MM₁, MM₂, MM₃, MM₄ whose electricity-generation systems 94, 95, 96, 97 have sufficient electricity-generation capacity to meet the aggregate electricity needs of mobile machines MM₁, MM₂, MM₃, MM₄. If information-processing system IPS₅ identifies multiple possible combinations of one or more of the electricity-generation systems 94, 95, 96, 97 capable of meeting the aggregate electricity needs of the group, information-processing system IPS₅ may use information about the efficiency characteristics of the various electricity-generation systems 94, 95, 96, 97 to determine which combination can most efficiently meet the group's aggregate electricity needs.

FIG. 2C shows another embodiment of the planning phase 101 of the method shown in FIG. 2A. In this case, step 100 may include information-processing system IPS₅ receiving from the information-processing systems IPS₁, IPS₂, IPS₃, IPS₄ of mobile machines MM₁, MM₂, MM₃, MM₄ one or more offers to supply electricity (step 118). This may include receiving information about the terms under which the owners of those mobile machines MM₁, MM₂, MM₃, MM₄ are willing to sell electricity, including, but not limited to, information about the quantity of electricity the owner is willing to sell and at what price. Similarly, information-processing system IPS₅ may receive from the information-processing systems IPS₁, IPS₂, IPS₃, IPS₄ of mobile machines MM₁, MM₂, MM₃, MM₄ offers to buy electricity (step 120). This may include receiving information about the quantity of electricity the owners of each of those mobile machines MM₁, MM₂, MM₃, MM₄ desires and the price the owners are willing to pay for that electricity. Subsequently, information-processing system IPS₅ may determine which of mobile machines MM₁, MM₂, MM₃, MM₄ are available to supply electricity (step 102).

Information-processing system IPS₅ may then determine which of mobile machines MM₁, MM₂, MM₃, MM₄ will receive electricity and which will supply electricity by matching offers to sell with offers to buy (step 122). This may involve determining which offers to sell electricity have terms that agree with the terms of one or more offers to sell, such as a sale price at or below the price associated with one or more of the offers to sell. Information-processing system IPS₅ may employ various known methods to accomplish this end. Additionally, information-processing system IPS₅ may use information about the prices at which the owner of electric utility grid UG is willing to buy and/or sell electricity to determine whether electricity should be exchanged between electric utility grid UG and one or more of mobile machines MM₁, MM₂, MM₃, MM₄.

Methods according to the present disclosure for coordinating transfer of electricity amongst mobile machines MM₁, MM₂, MM₃, MM₄ and electric utility grid UG are not limited to the examples discussed above in connection with FIGS. 2A-2C. For instance, information-processing system IPS₅ may execute the actions shown in FIGS. 2A-2C in different orders. Similarly, a method according to the present disclosure may omit one or more of the actions shown in FIGS. 2A-2C and/or include one or more actions not shown in FIGS. 2A-2C. Additionally, instead of information-processing system IPS₅ coordinating the transfer of electricity, one or more of information-processing systems IPS₁, IPS₂, IPS₃, IPS₄ may coordinate the transfer of electricity. In some embodiments, multiple information-processing systems may collaborate to execute a method according to the present disclosure. Furthermore, a method according to the present disclosure may utilize one or more features of the approach shown in FIG. 2B in combination with one or more features of the approach shown in FIG. 2C.

The disclosed methods represent practical means for enabling coordinated transfer of electricity between a plurality of parked mobile machines MM₁, MM₂, MM₃, MM₄. This may provide a number of benefits. Because they do not have the substantial overhead costs associated with electric utility grid UG, the owners of parked mobile machines MM₁, MM₂, MM₃, MM₄ may be able to profitably provide electricity to other parked mobile machines MM₁, MM₂, MM₃, MM₄ at a price significantly below the price of electricity from electric utility grid UG.

Additionally, transferring electricity between mobile machines MM₁, MM₂, MM₃, MM₄ may allow consumption of electricity by a large number of the mobile machines MM₁, MM₂, MM₃, MM₄, with only a small number of the electricity-generation systems 94, 95, 96, 97 of mobile machines MM₁, MM₂, MM₃, MM₄ operating. This may allow meeting the aggregate electricity needs of the parked mobile machines MM₁, MM₂, MM₃, MM₄ more efficiently than by operating the electricity-generation system 94, 95, 96, 97 of each mobile machine MM₁, MM₂, MM₃, MM₄ whose electrical power loads 74, 75, 76, 77 need electricity. This benefit may accrue because one of electricity-generation systems 94, 95, 96, 97 may generate a relatively large amount of electricity more efficiently than a plurality of electricity-generation systems 94, 95, 96, 97 collectively generating the same quantity of electricity. Furthermore, transferring electricity between mobile machines MM₁, MM₂, MM₃, MM₄, and thereby reducing the number of electricity-generation-systems 94, 95, 96, 97 operating at any one time, may facilitate meeting the electricity needs of all of the parked mobile machines MM₁, MM₂, MM₃, MM₄ while complying with laws and/or regulations relating to operation of parked mobile machines.

The disclosed methods and systems may prove particularly advantageous as the use of electricity in mobile machines increases. Many of the systems of many mobile machines in use today rely on operation of an engine of the mobile machine to allow them to perform their tasks. For example, air conditioning systems of many mobile machines rely on an engine of the mobile machine to drive an air conditioning compressor to enable the air conditioning system to function. Similarly, heating systems of many mobile machines rely on heat from the cooling liquid of the engine to heat the mobile machine, which may make it necessary for the engine to operate at least intermittently to maintain the engine cooling liquid warm enough to provide heat. In the future, these and other systems of mobile machines may increasingly operate entirely electrically. Among other factors, the increasing use of hybrid electric and pure electric propulsion systems in mobile machines may drive increased use of electricity in other systems of the mobile machine to take advantage of the relatively large quantity of electricity available from the electricity sources associated with the propulsion system. In combination with increased prevalence of electrically operated systems on mobile machines, the disclosed systems and methods may significantly reduce the need to operate engines of parked mobile machines because many of the parked mobile machines receiving electricity in the exchange coordinated by the disclosed system and methods may meet their operating needs entirely with that electricity.

It will be apparent to those skilled in the art that various modifications and variations can be made in the disclosed system and methods without departing from the scope of the disclosure. Other embodiments of the disclosed system and methods will be apparent to those skilled in the art from consideration of the specification and practice of the system and methods disclosed herein. It is intended that the specification and examples be considered as exemplary only, with a true scope of the disclosure being indicated by the following claims and their equivalents.

What is claimed is:

1. A system for coordinating transfer of electricity between parked mobile machines, each of the parked mobile machines having a propulsion system operable to propel the mobile machine, and one or more of the parked mobile machines having an electricity-generation system, the system comprising:
one or more information-processing devices that automatically coordinate one or more aspects of the transfer of electricity between a plurality of the parked mobile machines, including
receiving information relating to one or more of the parked mobile machines; and
automatically determining which of the plurality of parked mobile machines will supply electricity to one or more of the other parked mobile machines based at least in part on the received information.

2. The system of claim 1, wherein the information relating to one or more of the parked mobile machines includes information relating to the electricity needs of one or more of the parked mobile machines.

3. The system of claim 2, wherein the information relating to one or more of the parked mobile machines includes information relating to the capacity of the electricity-generation system of one or more of the parked mobile machines to supply electricity.

4. The system of claim 1, wherein automatically determining which of the parked mobile machines will supply electricity to one or more of the other parked mobile machines includes doing so based at least in part on efficiency characteristics of the electricity-generation system of one or more of the parked mobile machines.

5. The system of claim 1, wherein automatically determining which of the plurality of parked mobile machines will supply electricity to one or more of the other parked mobile machines based at least in part on the information related to one or more of the parked mobile machines includes doing so based at least in part on which of the plurality of parked mobile machines are parked inside a structure.

6. The system of claim 1, wherein the information relating to one or more of the parked mobile machines includes information relating to terms under which one or more of the owners of the plurality of parked mobile machines are willing to supply electricity.

7. The system of claim 1, wherein the information relating to one or more of the parked mobile machines includes information relating to terms under which one or more of the owners of the plurality of parked mobile machines are willing to receive electricity.

8. The system of claim 1, wherein automatically determining which of the plurality of parked mobile machines will supply electricity to one or more of the other parked mobile machines based at least in part on the information related to each of the plurality of parked mobile machines includes doing so based at least in part on one or more rules or laws related to operation of parked mobile machines.

9. The system of claim 1, wherein the information relating to one or more of the plurality of parked mobile machines includes identifying information for one or more of the parked mobile machines.

10. A method for coordinating transfer of electricity between parked mobile machines, each of the parked mobile machines having a propulsion system operable to propel the mobile machine, and one or more of the parked mobile machines having an electricity-generation system, the method comprising:
automatically selecting with one or more information-processing devices one or more of a plurality of the parked mobile machines to supply electricity; and
automatically determining with the one or more information-processing devices which of the plurality of the parked mobile machines will receive electricity from the one or more mobile machines selected to supply electricity.

11. The method of claim 10, wherein automatically selecting one or more of the plurality of parked mobile machines to supply electricity includes doing so based at least in part on information relating to terms under which one or more of the owners of the plurality of parked mobile machines are willing to supply electricity.

12. The method of claim 10, wherein automatically determining which of the plurality of parked mobile machines will receive electricity from the one or more mobile machines selected to supply electricity includes doing so based at least in part on information relating to terms under which one or more of the owners of the plurality of parked mobile machines are willing to receive electricity.

13. The method of claim 10, wherein automatically selecting one or more of the plurality of parked mobile machines to supply electricity includes doing so based at least in part on information relating to the capacity of the electricity-generation system of one or more of the parked mobile machines to supply electricity.

14. The method of claim 10, wherein automatically selecting one or more of the plurality of parked mobile machines to supply electricity includes doing so based at least in part on one or more rules or laws related to operation of parked mobile machines.

15. The method of claim 10, wherein automatically selecting one or more of the plurality of parked mobile machines to supply electricity includes doing so based at least in part on information relating to the electricity needs of one or more of the parked mobile machines.

16. The method of claim 10, wherein automatically selecting one or more of the plurality of parked mobile machines to supply electricity includes doing so based at least in part on efficiency characteristics of the electricity-generation system of one or more of the parked mobile machines.

17. A method for coordinating supply of electricity from one or more of a plurality of parked mobile machines to one or more external power loads, each of the parked mobile machines having a propulsion system operable to propel the mobile machine, and one or more of the parked mobile machines having an electricity-generation system operable to generate electricity, the method comprising:
automatically selecting with one or more information-processing devices one or more of the plurality of parked mobile machines that will supply electricity to one or more external power loads based at least in part on one or more laws or regulations relating to operation of parked mobile machines.

18. The method of claim 17, wherein the one or more external power loads include one or more others of the plurality of parked mobile machines that receive electricity from the one or more parked mobile machines selected to supply electricity.

19. The method of claim 18, wherein automatically selecting one or more of the plurality of parked mobile machines that will supply electricity to one or more external power loads further includes selecting the one or more parked mobile machines that will supply electricity based at least in part on electricity needs of one or more of the parked mobile machines.

20. The method of claim 17, wherein automatically selecting the one or more parked mobile machines that will supply electricity to one or more external power loads further includes selecting the one or more parked mobile machines that will supply electricity based at least in part on information relating to terms under which one or more owners of one or more of the parked mobile machines are willing to supply electricity.
